(19) United States
(12) Patent Application Publication
(10) Pub. No.: US 2010/0272059 A1
(43) Pub. Date: Oct. 28, 2010

(54) MOBILE RADIO COMMUNICATION DEVICES AND MOBILE RADIO BASE STATION DEVICES

(75) Inventors: Maik Bienas, Braunschweig (DE); Hyung-Nam Choi, Hamburg (DE); Achim Luft, Braunschweig (DE)

Correspondence Address: Viering, Jentschura & Partner, 3770 Highland Ave., Suite 203, Manhattan Beach, CA, 90266, US

(73) Assignee: INFINEON TECHNOLOGIES AG, Neubiberg (DE)

(21) Appl. No.: 12/431,032

(22) Filed: Apr. 28, 2009

(51) Int. Cl. H04B 7/216; H04W 4/00; H04W 72/00

(52) U.S. Cl. 370/330; 370/329; 455/450

(57) ABSTRACT

In various embodiments, a mobile radio communication device is provided. The mobile radio communication device may include a mobile radio communication protocol circuit configured to provide a home base station function for a mobile radio communication with a mobile radio communication terminal device, and a mobile radio resources allocation and reservation circuit configured to allocate and reserve mobile radio resources to a home base station for mobile radio user data transmission between the mobile radio communication device and the mobile radio communication terminal device.

### TECHNICAL FIELD

Various embodiments relate generally to mobile radio communication devices and mobile radio base station devices.

### BACKGROUND

Currently, the standardization body for mobile communication 3GPP (Third Generation Partnership Project) is specifying a new mobile radio network element called “Home eNodeB” (HeNB) in the release 8 versions of the LTE (Long Term Evolution) specifications. The term “Home eNode B” (HeNB) is usually used for the radio access technology (RAT) according to LTE, while the term “Home Node B” (HNB) is usually used for the radio access technology (RAT) according to UMTS (Universal Mobile Telecommunications System). Other terms are used interchangeably throughout the following text. Generally speaking, this mobile radio entity may be understood as being a modified eNodeB designed e.g. for use in buildings (with focus on home environments) in order to increase the in-building coverage and throughput. The typical use case is that a user of a mobile phone operates such HeNB as owner in his apartment. He may use his DSL (Digital Subscriber Line) connection to connect the HeNB to his mobile radio operator's core network. The usage may be beneficial for both mobile radio network operator and user, e.g. the user may save money and battery power of his mobile phone by improved in-house coverage when using his HNB and the mobile radio network operator may get additional mobile radio network coverage area and may save some energy costs.

One characteristic of a HeNB may be its flexibility in terms of mode of operation from a user point of view. A HeNB should be easy to use and small so that it can be used nomadically, i.e. the user may operate it one day in his apartment, and next day on a business trip in a hotel, for example. Additionally, the HeNB may be operated only temporarily, i.e. switched on and off from time to time, e.g. because the user may not want to operate it at night or when he leaves his apartment.

Further, to make the use of HeNBs for the owner as simple as possible, an automatic setup procedure (for registration and initial configuration of HeNBs in the network) may be desirable. Usually, this may be done by message exchanges between the HeNB and the corresponding entities in the mobile radio core network. Due to the possibly high number of HeNBs that can be deployed in the mobile radio operator's network, it may be desirable for the mobile radio network operator, that the message exchange should be as small as possible so that the amount of required signalling could be reduced as much as possible.

In contrast to regular eNodeBs, many HeNBs may be operated simultaneously in a small-scale area. Furthermore, the number of active mobile radio communication terminal devices supported by a HeNB may be very small.

The operation of eNodeBs and HeNBs, respectively using separate frequency bands may be costly from a mobile radio network operator's point of view (both in terms of work force to do the planning and some frequency range(s) that remain(s) unused), however, conventionally, for an eNodeB this is done only once. For HeNBs this would be much more costly, due to nomadic operation and the higher number of HeNBs. It would have to be done every time, a HeNB is switched on. Furthermore, the use of separate frequency bands for a HeNB may lead to waste of resources, as it is very likely, that the allocated resources may be unused most of the time due to the small number of active UEs (User Equipments) within the coverage area of a certain HeNB.

To avoid the usage of currently occupied shared resources, a conventional WLAN (Wireless Local Area Network) equipment may be configured to scan the resource for occupation and start transmission after the resource is idle for a certain time. This conventional method is also referred to as CSMA/CA (Carrier Sensing Multiple Access/Collision Avoidance). This is a very easy multiple access method that is designed to allocate the whole frequency bandwidth to one entity until the transmission time ends. With this method as such, however, it is not possible to offer different classes of quality of service at the same time and it is therefore not usable for mobile radio base stations of a cellular mobile radio communication network which should offer such different classes for quality of service.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows a portion of a mobile radio communication system in accordance with an embodiment;

FIG. 2 shows an exemplary frequency band allocation scheme for mobile radio home base station devices;

FIG. 3 shows a mobile radio communication device in accordance with an embodiment;

FIG. 4 shows a mobile radio communication device in accordance with another embodiment;

FIG. 5 shows a mobile radio base station device in accordance with an embodiment;

FIG. 6 shows a mobile radio base station device in accordance with another embodiment;

FIG. 7 shows a mobile radio base station device in accordance with yet another embodiment;

FIG. 8 shows a mobile radio base station device in accordance with yet another embodiment;

FIG. 9 shows a time/frequency diagram in accordance with an implementation of an embodiment;

FIG. 10 shows a time/frequency diagram in accordance with an implementation of an embodiment;

FIG. 11 shows a time/frequency diagram in accordance with another implementation of an embodiment;

FIG. 12 shows a time/frequency diagram in accordance with yet another implementation of an embodiment;

FIG. 13 shows a time/frequency diagram in accordance with yet another implementation of an embodiment; and

FIG. 14 shows a time/frequency diagram in accordance with yet another implementation of an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be software being implemented or executed by a processor, e.g. any kind of computer program, e.g. a computer program using a virtual machine code such as e.g. Java. Any other kind of implementation of the respective functions which will be described in more detail below may also be understood as a “circuit” in accordance with an alternative embodiment. Furthermore, a plurality of different circuits may also be implemented as one common circuit on one common substrate or in their functionalities by one processor executing the respective computer programs.

The terms “coupling” or “connection” are intended to include a direct “coupling” or direct “connection” as well as an indirect “coupling” or indirect “connection” respectively.

The term “protocol” is intended to include any piece of software, that is provided to implement part of any layer of the communication definition. “Protocol” may include the functionality of one or more of the following layers: physical layer (layer 1), data link layer (layer 2), network layer (layer 3), or any other sub-layer of the mentioned layers, or any upper layer.

As will be described in more detail below, various embodiments, relate to the question as to how a mobile radio base station device, e.g. a mobile radio home base station device, e.g. a HeNB device, which may be operated in immediate vicinity to one or more other mobile radio base station devices, e.g. one or more other mobile radio home base station devices, e.g. one or more other HeNB devices, can find usable spectrum parts for transmission and reception of user data requiring only a small amount of message exchange between the mobile radio base station device, e.g. the mobile radio home base station device, e.g. the HeNB device, and the mobile radio core network and without interfering the neighbouring mobile radio base station device(s), e.g. mobile radio home base station device(s), e.g. HeNB device(s). Therefore, various devices and methods for mobile radio resource reservation and mobile radio resource allocation for a mobile radio base station device, e.g. a mobile radio home base station device, e.g. a HeNB device, are provided and will be described in more detail below. By way of example, various devices and methods of mobile radio resource allocation and reservation and frequency planning for transmission of user data are provided. The different devices and methods may be configurable by the mobile radio network operator, for example, depending on the deployment scenario of mobile radio base station device(s), e.g. mobile radio home base station device(s), e.g. HeNB device(s).

In various embodiments, reservation of mobile radio resources may be understood as the allocation of the mobile radio resources even for the case that no user data are transmitted.

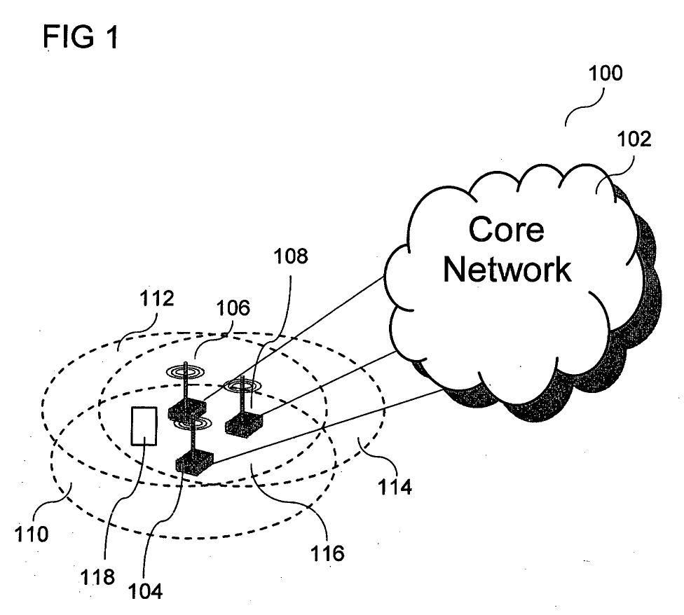

FIG. 1 shows a portion of a mobile radio communication system 100 in accordance with an embodiment. The mobile radio communication system 100 and its respective components, which will be described in more detail below, may be configured in accordance with one or more mobile radio communication technologies, e.g. in accordance with one or more of the following mobile radio communication technologies (which may also be referred to as Cellular Wide Area radio communication technologies):
a Global System for Mobile Communications (GSM) radio communication technology;
a General Packet Radio Service (GPRS) radio communication technology;
an Enhanced Data Rates for GSM Evolution (EDGE) radio communication technology; and
a Third Generation Partnership Project (3GPP) radio communication technology (e.g. UMTS (Universal Mobile Telecommunications System), FOMA (Freedom of Multimedia Access), 3GPP LTE (Long Term Evolution), 3GPP LTE Advance (Long Term Evolution Advance));
CDMA2000 (Code division multiple access 2000);
CDPD (Cellular Digital Packet Data);
Mobitex;
CSD (Circuit Switched Data);
HSCSD (High-Speed Circuit-Switched Data);
HSPA (High Speed Packet Access);
HSDPA (High-Speed Downlink Packet Access);
HSUPA (High-Speed Uplink Packet Access);
HSPA+ (High Speed Packet Access Plus);
UMTS-TDD (Universal Mobile Telecommunications System—Time-Division Duplex);
TD-CDMA (Time Division—Code Division Multiple Access);
TD-CDMA (Time Division—Synchronous Code Division Multiple Access);
3GPP Rel. 8 (Pre-4G) (3rd Generation Partnership Project Release 8 (Pre-4th Generation));
UTRA (UMTS Terrestrial Radio Access);
E-UTRA (Evolved UMTS Terrestrial Radio Access);
LTE Advanced (4G) (Long Term Evolution Advanced (4th Generation));
cdmaOne (2G);
CDMA2000 (3G);
EV-DO (Evolution-Data Optimized or Evolution-Data Only);
AMPS (1G) (Advanced Mobile Phone System (1st Generation));
TACS/ETACS (Total Access Communication System/Extended Total Access Communication System);
D-AMPS (2G) (Digital AMPS (2nd Generation));
PTT (Push-to-talk);
MTS (Mobile Telephone System);
IMTS (Improved Mobile Telephone System);
AMTS (Advanced Mobile Telephone System);
OLT (Norwegian for Offentlig Landmobil Telefoni, Public Land Mobile Telephony);
MTD (Swedish abbreviation for Mobiltelefonisystem D, or Mobile telephony system D);
Autotel/PALM (Public Automated Land Mobile);
ARP (Finnish for Autoradiopuhelin, “car radio phone”);
NMT (Nordic Mobile Telephony);
Hicap (high capacity version of NTT (Nippon Telegraph and Telephone));
CDPD (Cellular Digital Packet Data);
DataTAC;
iDEN (Integrated Digital Enhanced Network);
PDC (Personal Digital Cellular);
PHS (Personal Handy-phone System);
WiDEN (Wideband Integrated Digital Enhanced Network);
iBurst;
Unlicensed Mobile Access (UMA, also referred to as 3GPP Generic Access Network, or GAN standard).

In alternative embodiments, the mobile radio communication system 100 and its respective components, which will be described in more detail below, may be configured in accordance with a different mobile radio communication technology.

As shown in FIG. 1, the mobile radio communication system 100 may include a core network 102, which may include, e.g. in accordance with LTE, a Mobility Management Entity (MME) and a Serving Gateway (S-GW), and additional components and circuits, as desired and required. In case the mobile radio communication system 100 is configured in accordance with a different mobile radio communication technology, the core network 102 may include the respective components or circuits in accordance with the respective mobile radio communication technology.

In various embodiments, the mobile radio communication system 100 may further include one or more mobile radio base station devices 104, 106, 108, one or more of which may be configured as a fixed mobile radio base station device (not shown in the figures for reasons of simplicity), and one or more of which may be configured as so-called mobile radio home base station device(s) 104, 106, 108. Each mobile radio base station device, e.g. each mobile radio home base station device 104, 106, 108, has an assigned mobile radio coverage area 110, 112, 114. In various embodiments, a first mobile radio home base station device 104 may provide an assigned first mobile radio coverage area 110, a second mobile radio home base station device 106 may provide an assigned second mobile radio coverage area 112, and a third mobile radio home base station device 108 may provide an assigned third mobile radio coverage area 114.

As also shown in FIG. 1, in various embodiments, the mobile radio base station devices, e.g. the mobile radio home base station device 104, 106, 108, may provide mobile radio coverage areas 110, 112, 114 which may partially overlap with each other. In other words, in various embodiments, the mobile radio base stations may have one or more overlapping radio transmission regions, one example overlapping radio transmission region being designated in FIG. 1 with reference number 116.

In various embodiments, a mobile radio home base station device may be configured e.g. as a Home NodeB, e.g. as a Home (e)NodeB. In an example, a ‘Home NodeB’ may be understood in accordance with 3GPP as a trimmed-down version of a cellular mobile radio base station optimized for use in residential or corporate environments (e.g., private homes, public restaurants or small office areas). In various examples throughout this description, the terms ‘Home Base Station’, ‘Home NodeB’, ‘Home eNodeB’, and ‘Femto Cell’ are referring to the same logical entity and will be used interchangeably throughout the entire description.

The so-called ‘Home Base Station’ concept shall support receiving and initiating cellular calls at home, and uses a broadband connection (typically DSL, cable modem or fibre optics) to carry traffic to the operator's core network bypassing the macro network architecture (including legacy NodeBs or E-NodeBs, respectively), i.e. the legacy UTRAN or E-UTRAN, respectively. Femto Cells shall operate with all existing and future handsets rather than requiring customers to upgrade to expensive dual-mode handsets or UMA devices.

From the customer's perspective, ‘Home NodeBs’ offer the user a single mobile handset with a built-in personal phonebook for all calls, whether at home or elsewhere. Furthermore, for the user, there is only one contract and one bill. Yet another effect of providing ‘Home NodeBs’ may be seen in the improved indoor network coverage as well as in the increased traffic throughput. Moreover, power consumption may be reduced as the radio link quality between a handset and a ‘Home Base Station’ may be expected to be much better than the link between a handset and legacy ‘NodeB’.

In an embodiment, access to a ‘Home NodeB’ may be allowed for a closed user group only, i.e. the communication service offering may be restricted to employees of a particular company or family members, in general, to the members of the closed user group. This kind of ‘Home Base Stations’ may be referred to as ‘Closed Subscriber Group Cells’ (CSG Cells) in 3GPP. A mobile radio cell which indicates being a CSG Cell may need to provide its CSG Identity to the mobile radio communication terminal devices (e.g. the UEs). Such a mobile radio cell may only be suitable for a mobile radio communication terminal device if its CSG Identity is e.g. listed in the mobile radio communication terminal device's CSG white list (a list of CSG Identities maintained in the mobile radio communication terminal device or in an associated smart card indicating the mobile radio cells which a particular mobile radio communication terminal device is allowed to use for communication). In various embodiments, a home base station may be a consumer device that is connected to the mobile radio core network via fixed line (e.g. DSL) or wireless to a mobile radio macro cell. It may provide access to legacy mobile devices and increase the coverage in buildings and the bandwidth per user. In various embodiments, a home base station may be run in open or closed mode. In closed mode the home base station may provide access to a so-called closed subscriber group (CSG) only. Examples for such closed subscriber groups are families or some or all employees of a company, for example.

As a ‘Femto Cell’ entity or ‘Home Base Station’ entity will usually be a box of small size and physically under control of the user, in other words, out of the MNO's domain, it could be used nomadically, i.e. the user may decide to operate it in his apartment, but also in a hotel when he is away from home, e.g. as a business traveller. Additionally a ‘Home NodeB’ may be operated only temporarily, i.e. it can be switched on and off from time to time, e.g. because the user does not want to operate it over night or when he leaves his apartment. It is to be noted that the terms ‘Femto Cell’ or ‘Home Base Station’ are not limited to a 3GPP mobile radio communication technology.

In various embodiments, the mobile radio communication system 100 may farther include one or more mobile radio communication terminal devices 118 (in FIG. 1, only one mobile radio communication terminal device 118 is shown for reasons of simplicity, however, in general, a plurality or a multiplicity, in general an arbitrary number of mobile radio communication terminal devices 118 may be provided in the mobile radio communication system 100).

In various embodiments configured according to LTE, scalable bandwidths of [1.4, 3, 5, 10, 15, 20] MHz may be supported. Furthermore, various embodiments configured according to LTE may be based on new multiple access methods, i.e. OFDMA/TDMA (Orthogonal Frequency Division Multiple Access/Time Division Multiple Access) in downlink signal transmission direction (Downlink: e.g. signal transmission direction from the respective associated mobile radio base station device 104, 106, 108, to the mobile radio communication terminal device 118) and SC-FDMA/TDMA (Single Carrier-Frequency Division Multiple Access/Time Division Multiple Access) in uplink signal transmission direction (Uplink: e.g. signal transmission direction from the mobile radio communication terminal device 118 to the respective mobile radio base station device 104, 106, 108). Depending on the available spectrum, a mobile radio network operator may have a coordinated spectrum allocation approach applied, i.e. the regular (e.g. fixed) mobile radio base station devices (e.g. regular NodeBs or eNodeBs) may be operated either using the same frequency band or separate frequency bands. The same principle may also apply for operating mobile radio home base station devices (e.g. HNBs or HeNBs).

In various embodiments, in contrast to regular (e.g. fixed) mobile radio base station devices (e.g. regular (e.g. fixed) eNodeBs), many mobile radio home base station devices (e.g HNBs or HeNBs) may be operated simultaneously in a small-scale area. Furthermore, the number of active mobile radio communication terminal devices supported by a single mobile radio home base station device (e.g HNB or HeNB) may be very small. Taking both facts into consideration, in various embodiments, new principles for resource allocation and reservation and e.g. frequency planning, may be provided and will be described in more detail below.

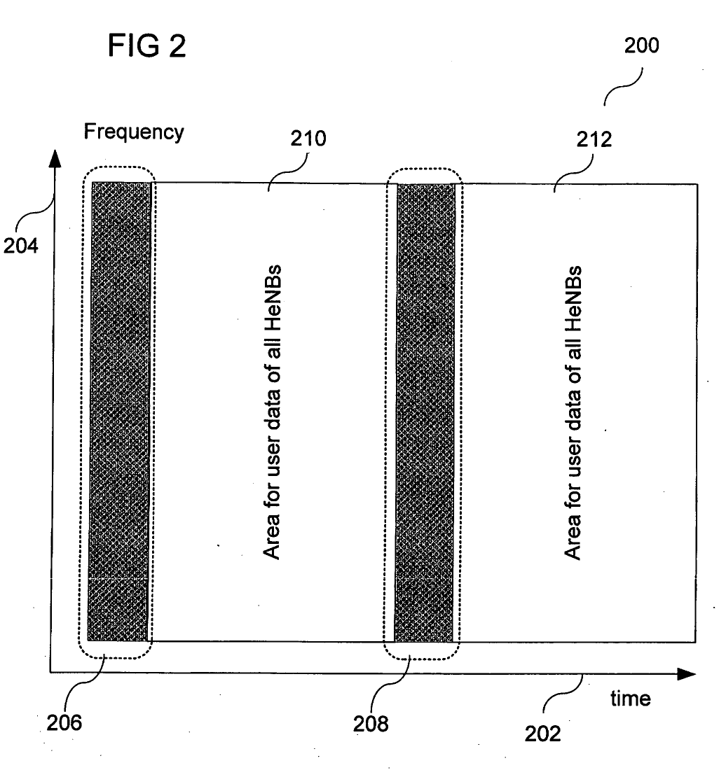

FIG. 2 shows an exemplary frequency band allocation scheme (in a time/frequency diagram 200) for mobile radio home base station devices (e.g. HNBs or HeNBs), e.g. for mobile radio home base station devices 104, 106, 108, with overlapping coverage areas (e.g. overlapping coverage region 116), wherein the available mobile radio resources may be divided into a plurality of, e.g. two, categories: one one for several mobile radio home base station devices (e.g. HNBs or HeNBs) for transmission of “permanent downlink signals” and one for several mobile radio home base station devices (e.g. HNBs or HeNBs) and several mobile radio communication terminal devices (e.g. UEs) 118 connected to different mobile radio home base station devices (e.g. HNBs or HeNBs) for transmission of user data. Permanent downlink signals may be understood as being signals and channels that may be transmitted by a mobile radio home base station device (e.g. HNB or HeNB) even in case that no mobile radio communication link to any mobile radio communication terminal device (e.g. UE) is established, i.e. system information and synchronization signals, for example. For simplifying matters, only the downlink part for the LTE FDD air interface is shown in FIG. 2 and will be described in more detail below. However, it is to be noted that the embodiments, may also be applied without substantial changes to the uplink part. The underlying deployment scenario in FIG. 2 is, that for instance a 20 MHz frequency band is shared by several mobile radio home base station devices (e.g. HNBs or HeNBs). In alternative embodiments, other frequency bands, in general other mobile radio resources (such as e.g. frequency bands, time slots, code division multiplexing codes) may be shared by several mobile radio home base station devices (e.g. HNBs or HeNBs). Illustratively, FIG. 2 shows a time/frequency arrangement for simultaneous operation of several mobile radio home base station devices (e.g. HNBs or HeNBs).

As shown in the time/frequency diagram 200 in FIG. 2, a time axis 202 and a frequency axis 204 are provided. First time/frequency portions (e.g. time slots) 206, 208 may be provided for the transmission of permanent downlink signals and second time/frequency portions (e.g. time slots) 210, 212 may be provided for the transmission of user data signals, wherein in various embodiments, the time/frequency resources may be shared by a plurality or even all mobile radio home base station devices (e.g. HNBs or HeNBs) having one or more overlapping radio transmission regions (and being e.g. registered with the mobile radio core network and being active for transmission of user data).

Various embodiments provide implementation as to how resources for the transmission of user data (in time and frequency (and possibly code division multiplexing codes)) can be efficiently allocated to mobile radio home base station devices (e.g. HNBs or HeNBs) and to mobile radio communication terminal devices (e.g. UEs).

In various embodiments, several mobile radio home base station devices (e.g. HNBs or HeNBs) may be operated simultaneously in the same frequency range with minimal configuration and signaling effort by the mobile radio core network (e.g. the mobile radio core network 102). To achieve this, in various embodiments, a multiplexing scheme for transmission of user data of different mobile radio home base station devices (e.g. HNBs or HeNBs) will be described in more detail below.

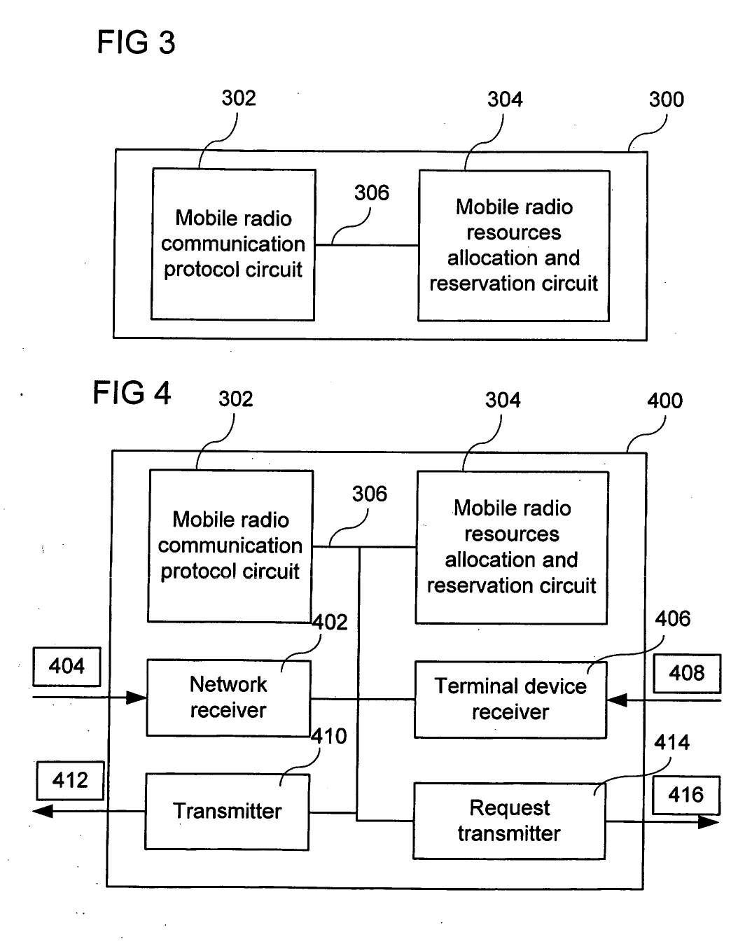

FIG. 3 shows a mobile radio communication device 300 in accordance with an embodiment (which may be an implementation of the mobile radio home base station devices 104, 106, 108).

In various embodiments, the mobile radio communication device 300 may include a mobile radio communication protocol circuit 302 configured to provide a home base station function for a mobile radio communication with a mobile radio communication terminal device (such as e.g. the mobile radio communication terminal device 118), and a mobile radio resources allocation and reservation circuit 304 configured to allocate and reserve mobile radio resources to a home base station for mobile radio user data transmission between the mobile radio communication device 300 and the mobile radio communication terminal device (such as e.g. the mobile radio communication terminal device 118). In various embodiments, the mobile radio communication protocol circuit 302 and the mobile radio resources allocation and reservation circuit 304 may be coupled with each other via an electrical connection (e.g. a cable or one or more electrically conductive lines, e.g. a computer bus connection) 306.

FIG. 4 shows a mobile radio communication device 400 in accordance with another embodiment (which may be another implementation of the mobile radio home base station devices 104, 106, 108).

The mobile radio communication device 400 of FIG. 4 may be similar to the mobile radio communication device 300 of FIG. 3, and may further include a network receiver 402 configured to receive mobile radio resources allocation and reservation information 404 from a mobile radio network (such as e.g. the mobile radio core network 102), wherein the mobile radio resources allocation and reservation information 404 may represent information about allocation and reservation of mobile radio resources for mobile radio user data transmission between the mobile radio communication device 400 and the mobile radio communication terminal device (such as e.g. the mobile radio communication terminal device 118). In various embodiments, the mobile radio resources allocation and reservation circuit 304 may be configured to allocate and reserve mobile radio resources to a home base station for mobile radio user data transmission between the mobile radio communication device 400 and the mobile radio communication terminal device (such as e.g. the mobile radio communication terminal device 118) in accordance with the received mobile radio resources allocation and reservation information 404.

Furthermore, in an implementation of the mobile radio communication device 400 of FIG. 4 or of the mobile radio communication device 300 of FIG. 3, the mobile radio resources allocation and reservation circuit 304 may be configured to allocate and reserve mobile radio resources to a home base station for mobile radio user data downlink transmission from the mobile radio communication device 300, 400 to the mobile radio communication terminal device (such as e.g. the mobile radio communication terminal device 118). In an alternative implementation of the mobile radio communication device 400 of FIG. 4 or of the mobile radio communication device 300 of FIG. 3, the mobile radio resources allocation and reservation circuit 304 may be configured to allocate and reserve mobile radio resources to a home base station for mobile radio user data uplink transmission from the mobile radio communication device 300, 400 to the mobile radio communication terminal device (such as e.g. the mobile radio communication terminal device 118).

Furthermore, in an implementation of the mobile radio communication device 400 of FIG. 4 or of the mobile radio communication device 300 of FIG. 3, the mobile radio resources allocation and reservation circuit 304 may be configured to allocate and reserve mobile radio resources to a home base station for mobile radio user data transmission between the mobile radio communication device 300, 400, and the mobile radio communication terminal device (such as e.g. the mobile radio communication terminal device 118) according to time multiplexing, frequency multiplexing, code division multiplexing, or a combination of the mentioned multiplexing techniques.

Furthermore, in an implementation of the mobile radio communication device 400 of FIG. 4 or of the mobile radio communication device 300 of FIG. 3, the mobile radio communication device 300, 400 may further include a terminal device receiver 406 configured to receive a connection setup request 408 from a mobile radio communication terminal device (such as e.g. mobile radio communication terminal device 118), whereas the mobile radio communication device 400 derives information about allocation and reservation of mobile radio resources for mobile radio user data transmission between the mobile radio communication device 300, 400, and the mobile radio communication terminal device (such as e.g. mobile radio communication terminal device 118) from this connection setup request. In case that e.g. a 3GPP-based mobile radio communication terminal device wants to establish a connection towards the packed switched domain, it may transmit an “Activate PDP Conext Request” message towards the mobile radio communication device 400 to the core network 102. This message may contain parameters related to the requested service, e.g. “Requested QoS”. This message may be an example for the connection setup message 408. The “Requested QoS” could be used, for instance, to derive information about allocation and reservation of mobile radio resources for mobile radio user data transmission between the mobile radio communication device 300, 400, and the mobile radio communication terminal device. In various implementations, the mobile radio resources allocation and reservation circuit 304 may be configured to allocate and reserve mobile radio resources to a home base station for mobile radio user data transmission between the mobile radio communication device 300, 400 and the mobile radio communication terminal device (such as e.g. mobile radio communication terminal device 118) in accordance with the received connection setup message 408.

Furthermore, in an implementation of the mobile radio communication device 400 of FIG. 4 or of the mobile radio communication device 300 of FIG. 3, the mobile radio communication device 300, 400 may further include a transmitter 410 configured to transmit reservation information 412 to another mobile radio communication device (such as e.g. another one of the mobile radio home base station devices 104, 106, 108).

In various implementations, the transmitter 410 may be configured to transmit pilot signals as reservation information 412 to the other mobile radio communication device (such as e.g. another one of the mobile radio home base station devices 104, 106, 108). The other mobile radio communication device may be a mobile radio base station device, e.g. a mobile radio home base station device.

It is to be noted that in various embodiments, the mobile radio communication device 400 may include only the network receiver 402 (and not the terminal device receiver 406) or only the terminal device receiver 406 (and not the network receiver 402).

However, in various embodiments, the mobile radio communication device 400 may include the network receiver 402 as well as the terminal device receiver 406. In these embodiments, the mobile radio resources allocation and reservation circuit 304 may be configured to allocate and reserve a first portion of mobile radio resources for mobile radio user data transmission between the mobile radio communication device 400 and the mobile radio communication terminal device (e.g. 118) in accordance with mobile radio resources allocation and reservation information 404 received from the mobile radio network (e.g. the core network 102), and to allocate and reserve a second portion of mobile radio resources for mobile radio user data transmission between the mobile radio communication device 400 and the mobile radio communication terminal device (e.g. 118) in accordance with the information derived from the connection setup request 408 received from the mobile radio communication terminal device (e.g. 118).

In various embodiments, the mobile radio resources allocation and reservation information may include at least one of the following information:
information about the amount of mobile radio resources to be allocated and reserved;
information specifying dedicated mobile radio resources to be allocated and reserved; and
information about an event resulting in a predefined allocation and reservation of mobile radio resources.

Furthermore, in an implementation of the mobile radio communication device 400 of FIG. 4 or of the mobile radio communication device 300 of FIG. 3, the mobile radio communication device 300, 400 may further include a request transmitter 414 configured to transmit a request 416 for mobile radio resources reservation to a mobile radio network (e.g. the core network 102).

In various embodiments, the network receiver 402, the terminal device receiver 406, the transmitter 410, and the request transmitter 414 may be coupled with each other (and with the mobile radio communication protocol circuit 302 and the mobile radio resources allocation and reservation circuit 304) via the electrical connection (e.g. a cable or one or more electrically conductive lines, e.g. a computer bus connection) 306.

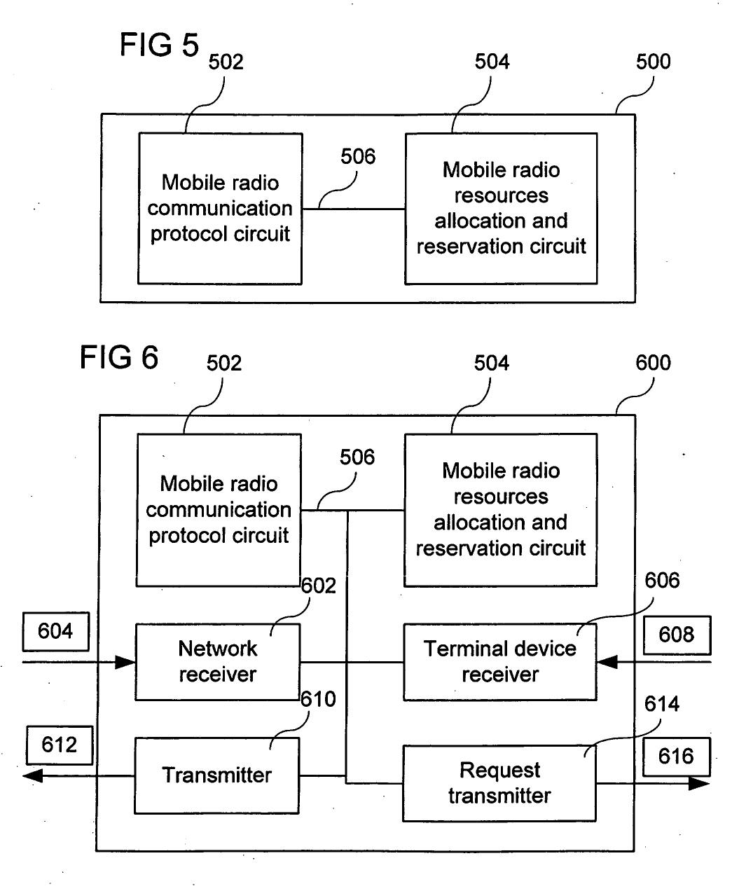

FIG. 5 shows a mobile radio base station device 500 in accordance with an embodiment (which may be an implementation of the mobile radio home base station devices 104, 106, 108).

In various embodiments, the mobile radio base station device 500 may include a mobile radio communication protocol circuit 502 configured to provide a base station function for a mobile radio communication with a mobile radio communication terminal device, and a mobile radio resources allocation and reservation circuit 504 configured to variably allocate and reserve radio resources for mobile radio user data transmission between the mobile radio base station device 500 and the mobile radio communication terminal device (e.g. 118) during run-time of the mobile radio base station device 500. In various embodiments, the mobile radio communication protocol circuit 502 and the mobile radio resources allocation and reservation circuit 504 may be coupled with each other via an electrical connection (e.g. a cable or one or more electrically conductive lines, e.g. a computer bus connection) 506.

FIG. 6 shows a mobile radio base station device 600 in accordance with another embodiment (which may be an implementation of the mobile radio home base station devices 104, 106, 108).

The mobile radio base station device 600 of FIG. 6 may be similar to the mobile radio base station device 500 of FIG. 5, and may further include a network receiver 602 configured to receive mobile radio resources allocation and reservation information 604 from a mobile radio network (such as e.g. the mobile radio core network 102), wherein the mobile radio resources allocation and reservation information 604 may represent information about allocation and reservation of mobile radio resources for mobile radio user data transmission between the mobile radio base station device 600 and the mobile radio communication terminal device (such as e.g. the mobile radio communication terminal device 118). In various embodiments, the mobile radio resources allocation and reservation circuit 504 may be configured to allocate and reserve mobile radio resources to a home base station for mobile radio user data transmission between the mobile radio base station device 600 and the mobile radio communication terminal device (such as e.g. the mobile radio communication terminal device 118) in accordance with the received mobile radio resources allocation and reservation information 604.

Furthermore, in an implementation of the mobile radio base station device 600 of FIG. 6 or of the mobile radio base station device 500 of FIG. 5, the mobile radio communication protocol circuit 504 may be configured to provide a home base station function for a mobile radio communication with a mobile radio communication terminal device.

Furthermore, in an implementation of the mobile radio base station device 600 of FIG. 6 or of the mobile radio base station device 500 of FIG. 5, the mobile radio resources allocation and reservation circuit 504 may be configured to allocate and reserve mobile radio resources to a home base station for mobile radio user data downlink transmission from the mobile radio base station device 500, 600 to the mobile radio communication terminal device (such as e.g. the mobile radio communication terminal device 118). In an alternative implementation of the mobile radio base station device 600 of FIG. 6 or of the mobile radio communication device 500 of FIG. 5, the mobile radio resources allocation and reservation circuit 504 may be configured to allocate and reserve mobile radio resources to a home base station for mobile radio user data uplink transmission from the mobile radio base station device 500, 600 to the mobile radio communication terminal device (such as e.g. the mobile radio communication terminal device 118).

Furthermore, in an implementation of the mobile radio base station device 600 of FIG. 6 or of the mobile radio base station device 500 of FIG. 5, the mobile radio resources allocation and reservation circuit 504 may be configured to allocate and reserve mobile radio resources to a home base station for mobile radio user data transmission between the mobile radio base station device 500, 600, and the mobile radio communication terminal device (such as e.g. the mobile radio communication terminal device 118) according to time multiplexing, frequency multiplexing, code division multiplexing, or a combination of the mentioned multiplexing techniques.

Furthermore, in an implementation of the mobile radio base station device 600 of FIG. 6 or of the mobile radio base station device 500 of FIG. 5, the mobile radio base station device 500, 600 may further include a terminal device receiver 606 configured to receive a connection setup request message 608 from a mobile radio communication terminal device (such as e.g. mobile radio communication terminal device 118), whereas the mobile radio communication device 600 derives information about allocation and reservation of mobile radio resources for mobile radio user data transmission between the mobile radio base station device 500, 600, and the mobile radio communication terminal device (such as e.g. mobile radio communication terminal device 118) from this connection setup request message 608. In various implementations, the mobile radio resources allocation and reservation circuit 504 may be configured to allocate and reserve mobile radio resources to a home base station for mobile radio user data transmission between the mobile radio base station device 500, 600 and the mobile radio communication terminal device (such as e.g. mobile radio communication terminal device 118) in accordance with the received connection setup request message 608.

Furthermore, in an implementation of the mobile radio base station device 600 of FIG. 6 or of the mobile radio base station device 500 of FIG. 5, the mobile radio base station device 500, 600 may further include a transmitter 610 configured to transmit reservation information 612 to another mobile radio communication device (such as e.g. another one of the mobile radio home base station devices 104, 106, 108).

In various implementations, the transmitter 610 may be configured to transmit pilot signals as reservation information 612 to the other mobile radio communication device (such as e.g. another one of the mobile radio home base station devices 104, 106, 108). The other mobile radio communication device may be a mobile radio base station device, e.g. a mobile radio home base station device.

It is to be noted that in various embodiments, the mobile radio base station device 600 may include only the network receiver 602 (and not the terminal device receiver 606) or only the terminal device receiver 606 (and not the network receiver 602).

However, in various embodiments, the mobile radio base station device 600 may include the network receiver 602 as well as the terminal device receiver 606. In these embodiments, the mobile radio resources allocation and reservation circuit 504 may be configured to allocate and reserve a first portion of mobile radio resources for mobile radio user data transmission between the mobile radio base station device 600 and the mobile radio communication terminal device (e.g. 118) in accordance with mobile radio resources allocation and reservation information 604 received from the mobile radio network (e.g. the core network 102), and to allocate and reserve a second portion of mobile radio resources for mobile radio user data transmission between the mobile radio base station device 600 and the mobile radio communication terminal device (e.g. 118) in accordance with the information derived from the connection setup request message 608 received from the mobile radio communication terminal device (e.g. 118).

In various embodiments, the mobile radio resources allocation and reservation information may include at least one of the following information:
information about the amount of mobile radio resources to be allocated and reserved;
information specifying dedicated mobile radio resources to be allocated and reserved; and
information about an event resulting in a predefined allocation and reservation of mobile radio resources.

Furthermore, in an implementation of the mobile radio base station device 600 of FIG. 6 or of the mobile radio base station device 500 of FIG. 5, the mobile radio base station device 500, 600 may further include a request transmitter 614 configured to transmit a request 616 for mobile radio resources reservation to a mobile radio network (e.g. the core network 102).

In various embodiments, the network receiver 602, the terminal device receiver 606, the transmitter 610, and the request transmitter 614 may be coupled with each other (and with the mobile radio communication protocol circuit 502 and the mobile radio resources allocation and reservation circuit 504) via the electrical connection (e.g. a cable or one or more electrically conductive lines, e.g. a computer bus connection) 506.

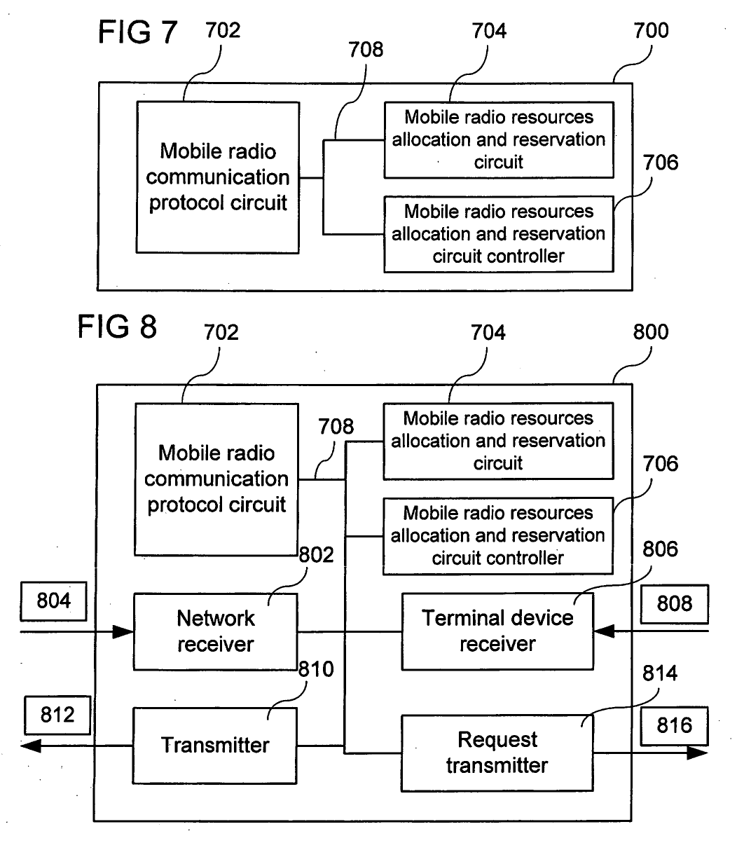

FIG. 7 shows a mobile radio base station device 700 in accordance with yet another embodiment (which may be an implementation of the mobile radio home base station devices 104, 106, 108). In various embodiments, the mobile radio base station device 700 may include a mobile radio communication protocol circuit 702 configured to provide a base station function for a mobile radio communication with a mobile radio communication terminal device (such as e.g. the mobile radio communication terminal device 118), a mobile radio resources allocation and reservation circuit 704 configured to allocate and reserve radio resources for radio user data transmission between the mobile radio base station device 700 and the radio communication terminal device (such as e.g. the mobile radio communication terminal device 118), and a mobile radio resources allocation and reservation circuit controller 706 configured to control allocation and reservation of radio resources for mobile radio user data transmission between the mobile radio base station device 700 and the mobile radio communication terminal device (such as e.g. the mobile radio communication terminal device 118).

FIG. 8 shows a mobile radio base station device 800 in accordance with yet another embodiment (which may be an implementation of the mobile radio home base station devices 104, 106, 108).

The mobile radio base station device 800 of FIG. 8 may be similar to the mobile radio base station device 700 of FIG. 7, and may further include a network receiver 802 configured to receive mobile radio resources allocation and reservation information 804 from a mobile radio network (such as e.g. the mobile radio core network 102), wherein the mobile radio resources allocation and reservation information 804 may represent information about allocation and reservation of mobile radio resources for mobile radio user data transmission between the mobile radio base station device 800 and the mobile radio communication terminal device (such as e.g. the mobile radio communication terminal device 118). In various embodiments, the mobile radio resources allocation and reservation circuit controller 706 may be configured to control the mobile radio resources allocation and reservation circuit 704 to allocate and reserve mobile radio resources to a home base station for mobile radio user data transmission between the mobile radio base station device 800 and the mobile radio communication terminal device (such as e.g. the mobile radio communication terminal device 118) in accordance with the received mobile radio resources allocation and reservation information 804.

Furthermore, in an implementation of the mobile radio base station device 800 of FIG. 8 or of the mobile radio base station device 700 of FIG. 7, the mobile radio communication protocol circuit 702 may be configured to provide a home base station function for a mobile radio communication with a mobile radio communication terminal device.

Furthermore, in an implementation of the mobile radio base station device 800 of FIG. 8 or of the mobile radio base station device 700 of FIG. 7, the mobile radio resources allocation and reservation circuit controller 706 may be configured to control the mobile radio resources allocation and reservation circuit 704 to allocate and reserve mobile radio resources to a home base station for mobile radio user data downlink transmission from the mobile radio base station device 700, 800 to the mobile radio communication terminal device (such as e.g. the mobile radio communication terminal device 118). In an alternative implementation of the mobile radio base station device 800 of FIG. 8 or of the mobile radio communication device 700 of FIG. 7, the mobile radio resources allocation and reservation circuit controller 706 may be configured to control the mobile radio resources allocation and reservation circuit 704 to allocate and reserve mobile radio resources to a home base station for mobile radio user data uplink transmission from the mobile radio base station device 700, 800 to the mobile radio communication terminal device (such as e.g. the mobile radio communication terminal device 118).

Furthermore, in an implementation of the mobile radio base station device 800 of FIG. 8 or of the mobile radio base station device 700 of FIG. 7, the mobile radio resources allocation and reservation circuit controller 706 may be configured to control the mobile radio resources allocation and reservation circuit 704 to allocate and reserve mobile radio resources to a home base station for mobile radio user data transmission between the mobile radio base station device 700, 800, and the mobile radio communication terminal device (such as e.g. the mobile radio communication terminal device 118) according to time multiplexing, frequency multiplexing, code division multiplexing, or a combination of the mentioned multiplexing techniques.

Furthermore, in an implementation of the mobile radio base station device 800 of FIG. 8 or of the mobile radio base station device 700 of FIG. 7, the mobile radio base station device 700, 800 may further include a terminal device receiver 806 configured to receive a connection setup request message 808 from a mobile radio communication terminal device (such as e.g. mobile radio communication terminal device 118), whereas the mobile radio communication device 800 derives information about allocation and reservation of mobile radio resources for mobile radio user data transmission between the mobile radio base station device 700, 800, and the mobile radio communication terminal device (such as e.g. mobile radio communication terminal device 118) from this connection setup request message 808. In various implementations, the mobile radio resources allocation and reservation circuit 704 may be configured to allocate and reserve mobile radio resources to a home base station for mobile radio user data transmission between the mobile radio base station device 700, 800 and the mobile radio communication terminal device (such as e.g. mobile radio communication terminal device 118) in accordance with the information derived from the connection setup request message 808.

Furthermore, in an implementation of the mobile radio base station device 800 of FIG. 8 or of the mobile radio base station device 700 of FIG. 7, the mobile radio base station device 700, 800 may further include a transmitter 810 configured to transmit reservation information 812 to another mobile radio communication device (such as e.g. another one of the mobile radio home base station devices 104, 106, 108).

In various implementations, the transmitter 810 may be configured to transmit pilot signals as reservation information 812 to the other mobile radio communication device (such as e.g. another one of the mobile radio home base station devices 104, 106, 108). The other mobile radio communication device may be a mobile radio base station device, e.g. a mobile radio home base station device.

It is to be noted that in various embodiments, the mobile radio base station device 800 may include only the network receiver 802 (and not the terminal device receiver 806) or only the terminal device receiver 806 (and not the network receiver 802).

However, in various embodiments, the mobile radio base station device 800 may include the network receiver 802 as well as the terminal device receiver 806. In these embodiments, the mobile radio resources allocation and reservation circuit controller 706 may be configured to control the mobile radio resources allocation and reservation circuit 704 to allocate and reserve a first portion of mobile radio resources for mobile radio user data transmission between the mobile radio base station device 800 and the mobile radio communication terminal device (e.g. 118) in accordance with mobile radio resources allocation and reservation information 604 received from the mobile radio network (e.g. the core network 102), and to allocate and reserve a second portion of mobile radio resources for mobile radio user data transmission between the mobile radio base station device 800 and the mobile radio communication terminal device (e.g. 118) in accordance with the information derived from the connection setup request message 808 received from the mobile radio communication terminal device (e.g. 118).

In various embodiments, the mobile radio resources allocation and reservation information may include at least one of the following information:
information about the amount of mobile radio resources to be allocated and reserved;
information specifying dedicated mobile radio resources to be allocated and reserved; and
information about an event resulting in a predefined allocation and reservation of mobile radio resources.

Furthermore, in an implementation of the mobile radio base station device 800 of FIG. 8 or of the mobile radio base station device 700 of FIG. 7, the mobile radio base station device 700, 800 may further include a request transmitter 814 configured to transmit a request 816 for mobile radio resources reservation to a mobile radio network (e.g. the mobile radio core network 102).

In various embodiments, the network receiver 802, the terminal device receiver 806, the transmitter 810, and the request transmitter 814 may be coupled with each other (and with the mobile radio communication protocol circuit 702, the mobile radio resources allocation and reservation circuit 704 and the mobile radio resources allocation and reservation circuit controller 706) via the electrical connection (e.g. a cable or one or more electrically conductive lines, e.g. a computer bus connection) 708.

In various embodiments, a mobile radio communication device is provided, which may include a controller configured to implement a home base station function for a mobile radio communication with a mobile radio communication terminal device, and an allocation and reservation of mobile radio resources for mobile radio user data transmission between the mobile radio communication device and the mobile radio communication terminal device.

In various embodiments, a mobile radio communication device is provided, which may include a controller configured to implement a base station function for a mobile radio communication with a mobile radio communication terminal device, an allocation and reservation of mobile radio resources for mobile radio user data transmission between the mobile radio base station device and the mobile radio communication terminal device, and controlling the allocation and reservation of radio resources for mobile radio user data transmission between the mobile radio base station device and the mobile radio communication terminal device.

In the following, various implementations of the above described embodiments will be described in more detail.

In an implementation of various embodiments, an illustratively semi-static resource allocation and resource reservation for transmission of user data is provided (which may e.g. be implemented by the mobile radio resources allocation and reservation circuit 304, the mobile radio resources allocation and reservation circuit 504 or the mobile radio resources allocation and reservation circuit 704 together with the mobile radio resources allocation and reservation circuit controller 706).

In an implementation, the resource allocation and resource reservation may be configured by the mobile radio network (e.g. the mobile radio core network 102) after a successful registration of a mobile radio base station device (e.g. HNB or HeNB) as initial mode of operation or when a mobile radio base station device (e.g. HNB or HeNB) should provide mainly reliable types of services (i.e. services requiring periodic and fixed amount of resources), e.g. by ensuring a predefined quality of service (QoS).

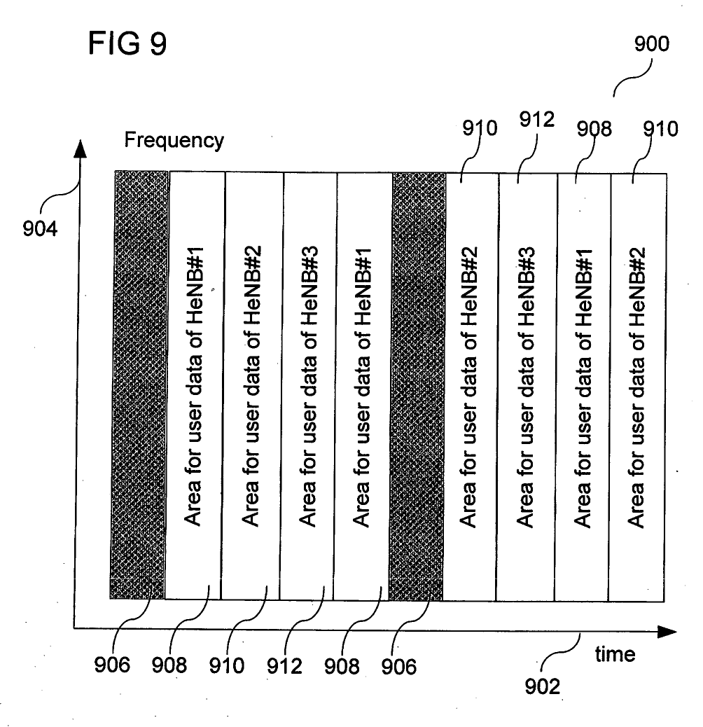

The mobile radio resources for user data transmission may be logically split in a number of parts (in other words, in a plurality of parts) e.g. in the time-domain which may equal the number of mobile radio base station devices (e.g. HNBs or HeNBs) deployed in a certain area and e.g. being registered at the mobile radio core network and being active for user data transmission in this area, as depicted in a time/frequency diagram 900 (including a time axis 902 and a frequency axis 904) in FIG. 9. By way of example, in case that three mobile radio base station devices (e.g. HNBs or HeNBs) are operated simultaneously in the same frequency range, three parts (in other words, three time slots) 908, 910, 912 in time-domain may be defined for user data transmission, wherein one respective time slot may be assigned to one respective mobile radio base station device (e.g. HNB or HeNB). Furthermore, one part (in other words, one time slot) 906 may be provided for the transmission of permanent downlink signals. By way of example, a first user data transmission time slot 908 may be assigned to a first mobile radio base station device (e.g. a first HNB or a first HeNB) (e.g. 104) for user data transmission, a second user data transmission time slot 910 may be assigned to a second mobile radio base station device (e.g. a second HNB or a second HeNB) (e.g. 106) for user data transmission, and a third user data transmission time slot 912 may be assigned to a third mobile radio base station device (e.g. a third HNB or a third HeNB) (e.g. 108) for user data transmission.

For simplification, it is assumed that all parts in time-domain (time axis 902) may be of the same size (in an alternative implementation of different sizes) and that time-multiplexing may be used (controlled e.g. by means of the mobile radio resources allocation and reservation circuit 304, 504 or by means of the mobile radio resources allocation and reservation circuit controller 704). Nevertheless, it is also a valid configuration in an alternative implementation that certain mobile radio base station devices (e.g. HNBs or HeNBs) may use more mobile radio resources than other mobile radio base station devices (e.g. HNBs or HeNBs) and that frequency-multiplexing or time- and frequency multiplexing (or even code division multiplexing) may be used. In this implementation, the mobile radio resources in frequency and time may be semi-statically allocated to each mobile radio base station device (e.g. HNB or HeNB), i.e. the mobile radio resources for user data may be allocated to mobile radio base station devices (e.g. HNBs or HeNBs) independent as to whether they are in use or not.

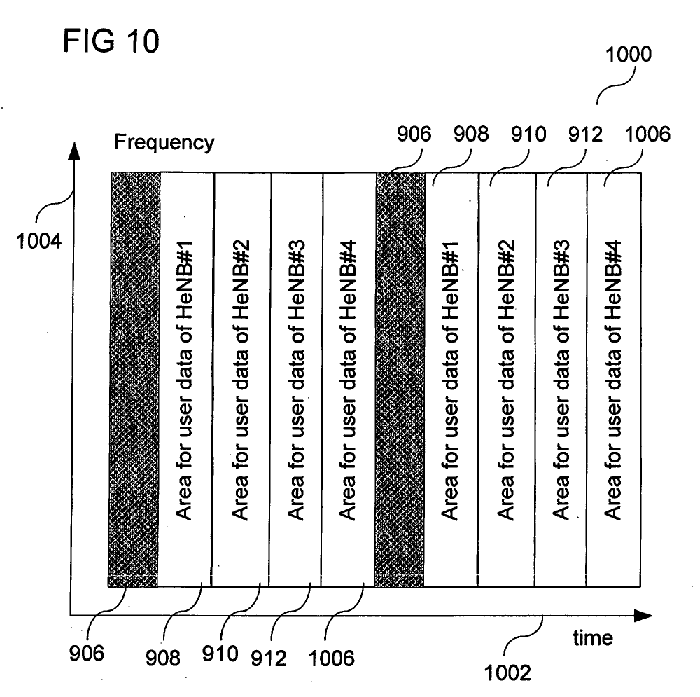

When an additional mobile radio base station device (e.g. HNB or HeNB) registers at the mobile radio network (e.g. at the mobile radio core network 102) and starts to operate in the same area as the first mobile radio base station device (e.g. HNB or HeNB, e.g. HeNB#1), the second mobile radio base station device (e.g. HNB or HeNB, e.g. HeNB#2) and the third mobile radio base station device (e.g. HNB or HeNB, e.g. HeNB#3), then the mobile radio network (e.g. mobile radio core network 102) may signal to the mobile radio base station devices (e.g. HeNB#1 to HeNB#3), that an additional mobile radio base station device (e.g. HNB or HeNB) is operated in the same area. These mobile radio base station devices (e.g. HeNB#1 to HeNB#3) may re-configure the area for user data transmission to provide a fourth logical part (e.g. a fourth time slot 1006) available as illustrated in a time/frequency diagram 1000 (including a time axis 1002 and a frequency axis 1004) in FIG. 4. Illustratively, FIG. 10 shows the re-configuration of mobile radio resources after a fourth mobile radio base station device (e.g. HeNB#4) starts operation. Split of mobile radio resources for user data in four logical parts may then be provided. All available mobile radio resources may be allocated independent whether they are needed or not. In an implementation, it may be assumed that the mobile radio network (e.g. mobile radio core network 102) knows those mobile radio base station devices (e.g. HeNB#1 to HeNB#4) that have overlapping coverage areas (e.g. 116) with the additional mobile radio base station device (e.g. HeNB#4).

This implementation is very simple and needs only very little signaling between the mobile radio base station devices (e.g. HNBs or HeNBs) and the mobile radio network (e.g. 102). In some implementations, it is sufficient that affected mobile radio base station devices (e.g. HNBs or HeNBs) are informed by the mobile radio network (e.g. the mobile radio core network 102) about an additional mobile radio base station device (e.g. HNB or HeNB). If a larger amount of mobile radio resources are allowed for certain mobile radio base station devices (e.g. HNBs or HeNBs), an additional signaling about the amount of the allocated mobile radio resources may be provided. Mobile radio communication terminal devices (e.g. UEs) are unaffected by some implementations. These implementations may be provided for deployment scenarios where the number of mobile radio base station devices (e.g. HNBs or HeNBs) simultaneously operating in an (one common) area is moderate and where each mobile radio base station device (e.g. HNB or HeNB) should provide mainly basic types of services, e.g. voice calls. In this case the mobile radio base station device (e.g. HNB or HeNB) can offer a reliable quality of service as the allocated mobile radio resources are for exclusive use for each mobile radio base station device (e.g. HNB or HeNB).

After a mobile radio base station device (e.g. HNB or HeNB) stops the operation, the reserved mobile radio resource may be released, i.e. the mobile radio network (e.g. the mobile radio core network 102) may detect the stop of operation and signals to the remaining mobile radio base station devices (e.g. HNBs or HeNBs), that one mobile radio base station device (e.g. HNB or HeNB) stops operation in this area. These mobile radio base station devices (e.g. HNBs or HeNBs) may re-configure the area for user data transmission to reduce the number of different logical parts (e.g. time slots).

In various implementations, the mobile radio network (e.g. the mobile radio core network 102) may reject the request for mobile radio resources of a mobile radio base station device (e.g. HNB or HeNB), e.g. in case that all mobile radio resources are already heavily loaded.

In another implementation of various embodiments, an illustratively fully-dynamic resource allocation and resource reservation for transmission of user data is provided (which may e.g. be implemented by the mobile radio resources allocation and reservation circuit 304, the mobile radio resources allocation and reservation circuit 504 or the mobile radio resources allocation and reservation circuit 704 together with the mobile radio resources allocation and reservation circuit controller 706).

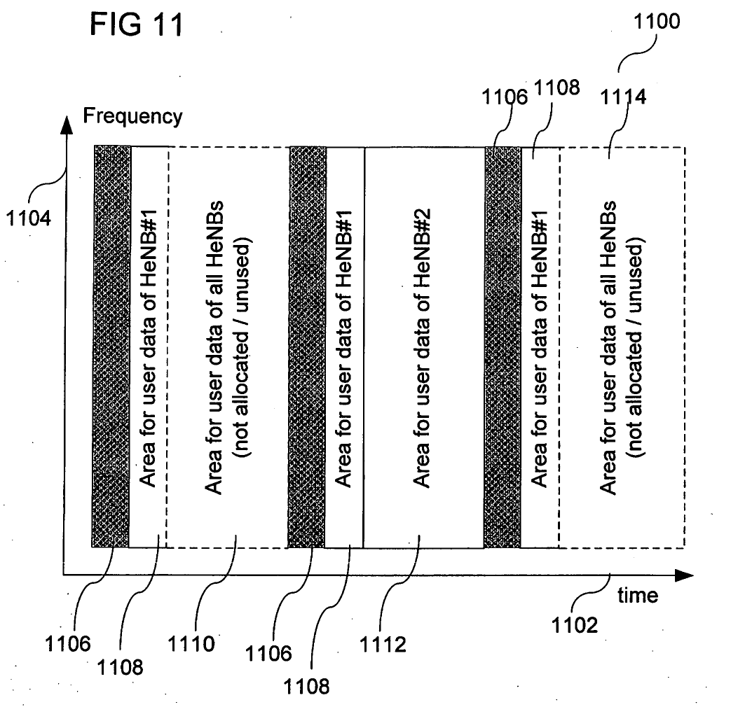

This implementation may be configured by the mobile radio network (e.g. the mobile radio core network 102) for deployment scenarios in which the mobile radio base station devices (e.g. HNBs or HeNBs) are mostly temporarily active in time or providing services with bursty traffic characteristics (i.e., for example, services requiring aperiodic and dynamic amount of mobile radio resources). The split of resources in accordance with this implementation is depicted in a time/frequency diagram 1100 (including a time axis 1102 and a frequency axis 1104) in FIG. 11.

In case, that no mobile radio communication terminal device (e.g. UE) is transmitting or receiving user data, no mobile radio resources from the area for user data transmission in the transmission resources allocation and reservation scheme have to be allocated to and reserved for the corresponding mobile radio base station device (e.g. HNB or HeNB). After a mobile radio communication terminal device (e.g. UE) requests mobile radio resources or data for a mobile radio communication terminal device (e.g. UE) arriving at a mobile radio base station device (e.g. HNB or HeNB), appropriate mobile radio resources may be reserved by the mobile radio base station device (e.g. HNB or HeNB) and allocated to the (arriving) mobile radio communication terminal device (e.g. UE). This could be the complete area for user data transmission or parts thereof. The serving mobile radio base station device (e.g. HNB or HeNB) may select an appropriate area for user data transmission in the transmission resources allocation and reservation scheme (as shown in the time/frequency diagram 1100 in FIG. 11, for example), broadcasts a “special signal” that indicates this area towards neighboring mobile radio base station devices (e.g. HNBs or HeNBs) as reserved and allocates a part or all of these reserved mobile radio resources to the requesting (newly arriving) mobile radio communication terminal device (e.g. UE). The “special signal” could be some or all pilot signals, which are transmitted in the allocated part of the spectrum, or could be transmitted as part of broadcasted system information (e.g. in a master information block (MIB) or a system information block (SIB)).

After the connection between the mobile radio communication terminal device (e.g. UE) and the mobile radio base station device (e.g. HNB or HeNB) is terminated, the mobile radio resource may be released and could be used by other mobile radio base station devices (e.g. HNBs or HeNBs). The mobile radio base station device (e.g. HNB or HeNB) may therefore stop transmitting the signal that indicates the reservation (e.g. the above mentioned “special signal”) or may transmit another “special signal” that indicates the end of the user data transmission. In another variant, the release of the mobile radio resource may be done automatically after the expiration of a predefined time period. This predefined time period may be semi-statically configured by the mobile radio network (e.g. the mobile radio core network 102). In yet another variant, the mobile radio base station device (e.g. HNB or HeNB) may not stop the transmission of the “special signal” even for the case that no user data are transmitted. Thus, the implementation is used to reserve this mobile radio resource.

This implementation may offer the most flexible and effective usage of the shared mobile radio resources. The main use case may be that the mobile radio resources are for some time not reserved, when no user data are transmitted.

As shown in FIG. 11, one part (e.g. one time slot) 1106 may be provided for the transmission of permanent downlink signals. Furthermore, the time/frequency diagram 1100 illustrates as an example that in a first time frame, one respective portion (e.g. time-slot) 1108 is allocated and reserved for the first mobile radio base station device (e.g. HNB or HeNB, e.g. HeNB#1), and another respective portion (in general area) (e.g. time-slot) 1110 is not yet allocated and reserved for a specific one of the mobile radio base station devices (e.g. HNBs or HeNBs), but may be allocated and reserved and is thus available for user data transmission for all mobile radio base station devices (e.g. HNBs or HeNBs) located in this coverage area. In other words, the respective other portion (e.g. time-slot) 1110 is currently unused.

After the second mobile radio base station device (e.g. HNB or HeNB, e.g. HeNB#2) has arrived and registered (e.g. at the mobile radio core network 102) and has requested for mobile radio resources for providing for one or more mobile radio communication terminal devices (this registration has been completed after or during the first frame time period), in the second frame, the other respective portion (e.g. time-slot) 1112 (which was unused in the first frame) may then be allocated and reserved by and for the second mobile radio base station device (e.g. HNB or HeNB, e.g. HeNB#2).

Then, in this implementation, only for illustrative purposes, it is assumed that the second mobile radio base station device (e.g. HNB or HeNB, e.g. HeNB#2) releases the allocated and reserved mobile radio resources for the third frame. Thus, the other respective portion (e.g. time-slot) 1114 (which was unused in the first frame and allocated and reserved in the second frame) is then again unused in the third frame.

Illustratively, in the above described implementation, a fully-dynamic mobile radio resource allocation may be provided as follows: the first mobile radio base station device (e.g. HNB or HeNB, e.g. HeNB#1) may use a small but persistent mobile radio resource; the second mobile radio base station device (e.g. HNB or HeNB, e.g. HeNB#2) may occupy a larger mobile radio resource but for only a short time period. Not needed resources may be free for usage by other mobile radio base station devices (e.g. HNBs or HeNBs).

In another implementation of various embodiments, an illustratively semi-dynamic resource allocation and resource reservation for transmission of user data is provided (which may e.g. be implemented by the mobile radio resources allocation and reservation circuit 304, the mobile radio resources allocation and reservation circuit 504 or the mobile radio resources allocation and reservation circuit 704 together with the mobile radio resources allocation and reservation circuit controller 706).

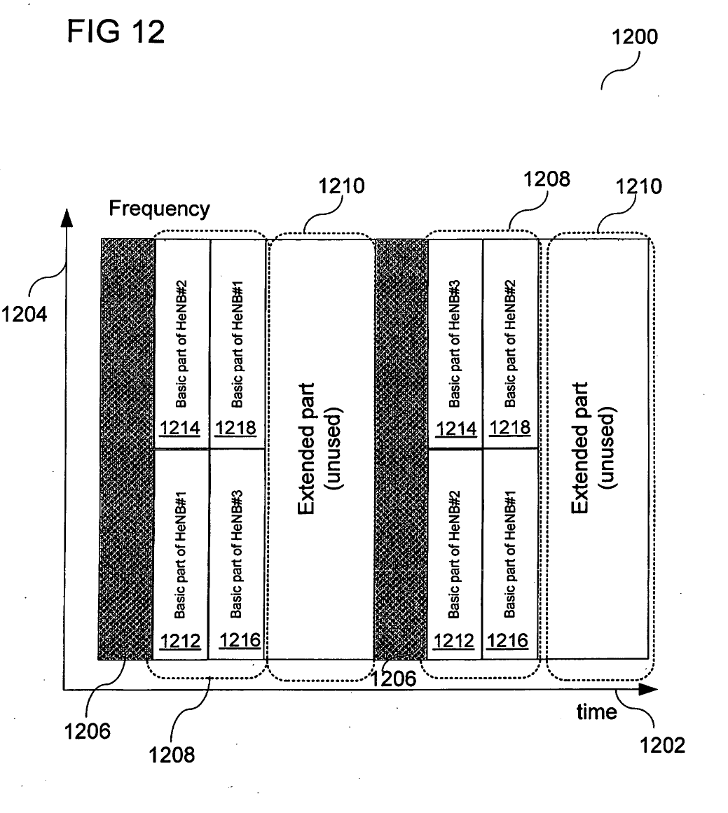

This implementation illustratively combines the first two above described implementations (i.e. semi-static and fully-dynamic resource allocation and reservation). The resources for user data transmission may be split into a plurality of, e.g. two, parts: One portion (e.g. time-slot or time/frequency slot) 1208 may be referred to as the “basic part” which may use the implementation principle of the implementation as described with reference to FIG. 9 and FIG. 10, and the other portion (e.g. time-slot or time/frequency slot) 1210 may be considered as the “extended part” which may use the implementation principle of the implementation as described with reference to FIG. 11. This is shown in a time/frequency diagram 1200 in FIG. 12 (including a time axis 1202 and a frequency axis 1204), in which one part (in other words, one time slot) 1206 may be provided for the transmission of permanent downlink signals. This implementation may also combine the effects of both above described implementations. This implementation may offer a flexible and effective usage of the shared mobile radio resources and may be well suited for usage scenarios varying from a small to a high number of users (e.g. mobile radio base station devices as well as mobile radio communication terminal devices) and from real-time services with low latency to background services with bursty traffic and high data rate peaks. The main part of the mobile radio resource may not permanently be reserved, when no user data are transmitted. Additionally, it may be very simple to allocate a basic set of mobile radio resources which may allow the mobile radio base station devices (e.g. HNBs or HeNBs) to offer reliable services. This implementation may need only very little signaling between the mobile radio base station devices (e.g. HNBs or HeNBs) and the mobile radio network (e.g. the mobile radio core network 102).

As shown in the time/frequency diagram 1200 in FIG. 12, the portion (e.g. time-slot or time/frequency slot) 1208 which may be referred to as the “basic part”, may include a plurality of sub-portions (e.g. sub-time-slots or sub-time/frequency slots) 1212, 1214, 1216, 1218, e.g. a first sub-portion (e.g. first sub-time/frequency slot) 1212, in the first frame allocated to and reserved for the first mobile radio base station device (e.g. HNB or HeNB, e.g. HeNB#1), a second sub-portion (e.g. second sub-time/frequency slot) 1214, in the first frame allocated to and reserved for the second mobile radio base station device (e.g. HNB or HeNB, e.g. HeNB#2), a third sub-portion (e.g. third sub-time/frequency slot) 1216, in the first frame allocated to and reserved for the third mobile radio base station device (e.g. HNB or HeNB, e.g. HeNB#3), and a fourth sub-portion (e.g. fourth sub-time/frequency slot) 1218, in the first frame allocated to and reserved for the first mobile radio base station device (e.g. HNB or HeNB, e.g. HeNB#1) again. Then, in this implementation, in the second frame, the first sub-portion (e.g. first sub-time/frequency slot) 1212 may be allocated to and reserved for the second mobile radio base station device (e.g. HNB or HeNB, e.g. HeNB#2), the second sub-portion (e.g. second sub-time/frequency slot) 1214 may be allocated to and reserved for the third mobile radio base station device (e.g. HNB or HeNB, e.g. HeNB#3), the third sub-portion (e.g. third sub-time/frequency slot) 1216 may be allocated to and reserved again for the first mobile radio base station device (e.g. HNB or HeNB, e.g. HeNB#1), and the fourth sub-portion (e.g. fourth sub-time/frequency slot) 1218 may be allocated to and reserved for the second mobile radio base station device (e.g. HNB or HeNB, e.g. HeNB#2), and so on.

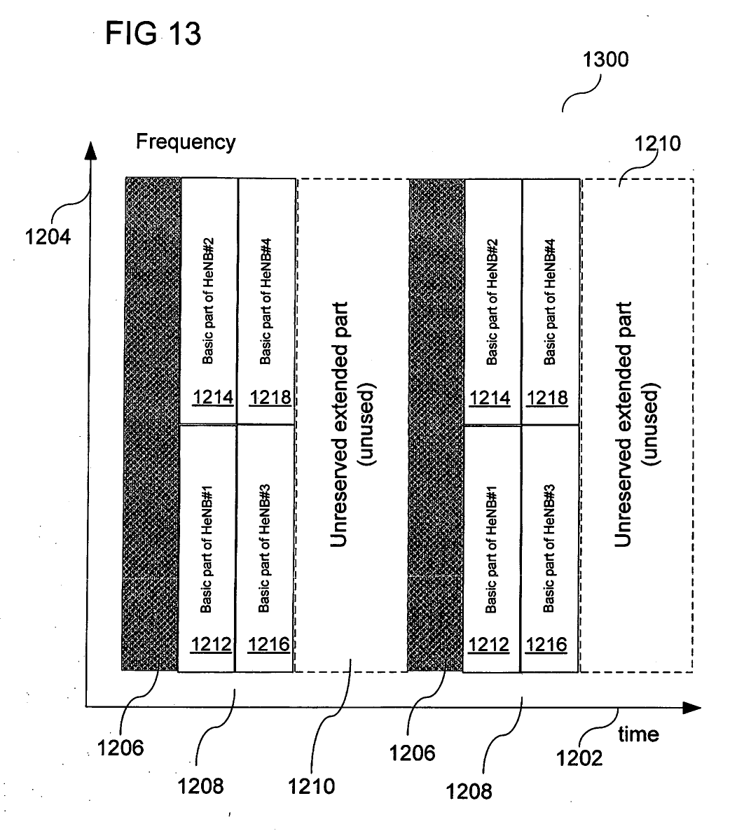

FIG. 13 shows a time/frequency diagram 1300 illustrating the mobile radio resource allocation situation in the implementation of FIG. 12, after a fourth mobile radio base station device (e.g. HNB or HeNB, e.g. HeNB#4) has entered the common coverage area and has registered itself to the mobile radio network (e.g. the mobile radio core network 102). As shown in the time/frequency diagram 1300, the fourth sub-portion (e.g. fourth sub-time/frequency slot) 1218 may, in the first frame, be allocated to and reserved for the fourth mobile radio base station device (e.g. HNB or HeNB, e.g. HeNB#4), and the repetition cycle is amended correspondingly. In other words, in this example, in the second frame, the first sub-portion (e.g. first sub-time/frequency slot) 1212 may be allocated to and reserved for the first mobile radio base station device (e.g. HNB or HeNB, e.g. HeNB#1), the second sub-portion (e.g. second sub-time/frequency slot) 1214 may be allocated to and reserved for the second mobile radio base station device (e.g. HNB or HeNB, e.g. HeNB#2), the third sub-portion (e.g. third sub-time/frequency slot) 1216 may be allocated to and reserved for the third mobile radio base station device (e.g. HNB or HeNB, e.g. HeNB#3), and the fourth sub-portion (e.g. fourth sub-time/frequency slot) 1218 may be allocated to and reserved for the fourth mobile radio base station device (e.g. HNB or HeNB, e.g. HeNB#4).

This implementation may be configured by the mobile radio network (such as e.g. the mobile radio core network 102) for deployment scenarios where mobile radio base station devices (e.g. HNBs or HeNBs) are operated providing mix of services, i.e. mobile radio base station devices (e.g. HNBs or HeNBs) providing reliable types of services (i.e. services requiring periodic and fixed amount of mobile radio resources) along with mobile radio base station devices (e.g. HNBs or HeNBs) providing services with bursty traffic characteristics (i.e. services requiring periodic and dynamic amount of mobile radio resources) and in case the mobile radio network operator could not classify the type of usage.

More details about the implementation shown in FIGS. 12 and 13 will be described further below.

After a mobile radio base station device (e.g. HNB or HeNB) starts operation, it registers at the mobile radio network (such as e.g. the mobile radio core network 102). Included in this registration message is information about the neighboring mobile radio base station devices (e.g. HNBs or HeNBs) which are located within the coverage area of this mobile radio base station device (e.g. HNB or HeNB) and an indication about the needed amount from the basic part of mobile radio resources. The mobile radio network may transmit a message to the registering mobile radio base station device (e.g. HNB or HeNB) with details about the frequency-time grid, i.e. the size of the basic part and the extended part in the user data transmission scheme, how many mobile radio resources from the basic part are in use by other mobile radio base station devices (e.g. HNBs or HeNBs) (a number that equals the number of currently allocated resources, i.e., for example, a “3”), how many mobile radio resources are allocated to this registering and requesting mobile radio base station device (e.g. HNB or HeNB) (in this example “1” may be used) and the time period after the usage of the extended part should be stopped. The mobile radio network may re-configure the basic area to make one additional logical part available. This may from now on be reserved for the requesting mobile radio base station device (e.g. HNB or HeNB). The reservation is indicated towards neighboring mobile radio base station devices (e.g. HNBs or HeNBs) by messages that are transmitted from the mobile radio network to the affected mobile radio base station devices (e.g. HNBs or HeNBs), e.g. a “1” for the newly allocated resource may be signaled (or a “2”, “3”, . . . in case the mobile radio base station device (e.g. HNB or HeNB) occupies 2, 3, . . . parts from the basic part). The re-configured time-frequency grid is depicted in FIG. 13.

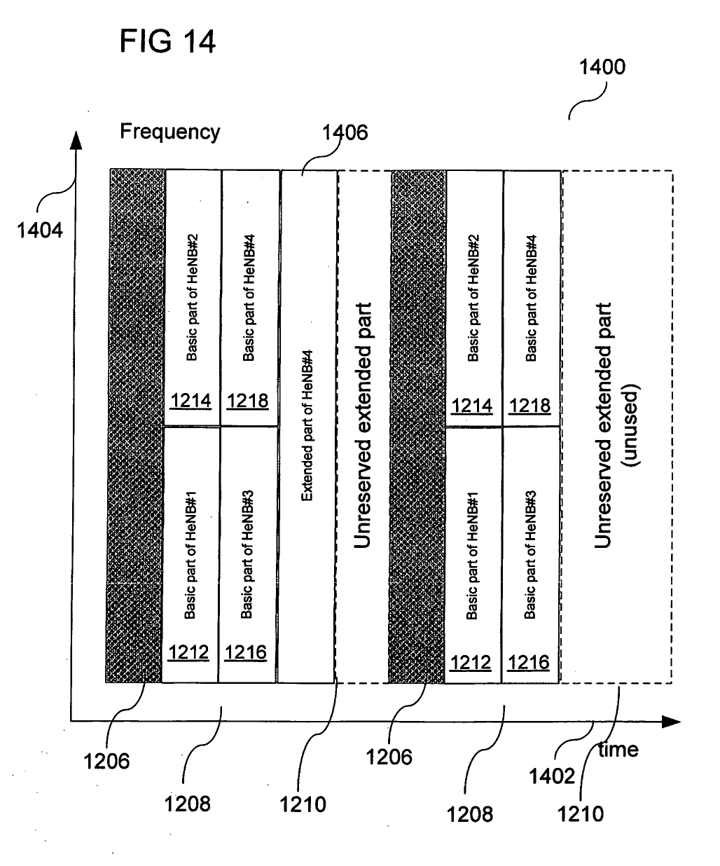

In case, that more mobile radio resources are needed by a mobile radio base station device (e.g. HNB or HeNB) than available in the basic part, e.g. due to requests from one or more mobile radio communication terminal devices (e.g. UEs) towards the mobile radio base station device (e.g. HNB or HeNB), the mobile radio base station device (e.g. HNB or HeNB) may try to reserve it. Therefore, it scans the extended part for signals, which indicate the reservation by other mobile radio base station devices (e.g. HNBs or HeNBs). From an unoccupied area of the spectrum it reserves a part (in FIG. 14 denoted with reference number 1406), which will fit to the need of the mobile radio communication terminal device (e.g. UE). The reservation may be indicated by transmission of pilot symbols in the reserved area. The re-configured time-frequency grid is depicted in a time/frequency diagram 1400 in FIG. 14 (which may include a time axis 1402 and a frequency axis 1404). In this example, it is assumed that the time period for the usage of the extended parts is the same as for transmission of permanent downlink signals. Therefore, the mobile radio resources are marked as “unused” in the right part of FIG. 14.

The method for allocating resources (which may e.g. be carried out by the respective mobile radio resources allocation and reservation circuit 304, 504 or the mobile radio resources allocation and reservation circuit controller 704) from the extended part may be as follows:

Basically, in an implementation, CSMA/CA may be used, with four differences, for example:

1. The indication whether the mobile radio resource is reserved or not may be based on the transmission of pilot symbols instead of transmission of the user data (as e.g. in a conventional WLAN system). This may enable a mobile radio base station device (e.g. HNB or HeNB) to reserve this mobile radio resource even in case that no user data are transmitted. This may be useful to enable a “circuit switched like” type of connection with a high reliability and low latency in addition to the mobile radio resources from the basic set.

2. The extended part may be logically split in several areas, which are configured by the mobile radio network (e.g. the mobile radio core network 102). Each area may be allocated by a separate CSMA/CA process. This may reduce the occurrence of collisions.

3. The start and end of a mobile radio resource allocation/reservation may not be arbitrary. In an implementation, it is predefined by a time period configured by the mobile radio network (e.g. the mobile radio core network 102).

4. The conventional usage of CSMA/CA is for allocation of resources, i.e. to occupy the resource by sending user data. In various implementations, the CSMA/CA technique is not only used for allocation but also for reservation, i.e. the mobile radio resources may be indicated as occupied even in case that no user data are transmitted.

Several options to release the mobile radio resources in the extended part could be applied in various implementations:

a) After the connection towards the mobile radio communication terminal device (e.g. UE) was terminated: The release could be done immediately after the mobile radio connection has been terminated, after expiration of a (e.g. predefined or negotiated) timer, which may start after the mobile radio connection has been terminated, after a mobile radio resource is requested by another mobile radio base station device (e.g. HNB or HeNB), when the mobile radio network instructs the mobile radio base station device (e.g. HNB or HeNB) to release the mobile radio resources; or

b) after the signaled time period expires, as assumed in the above implementation.

When the mobile radio resources in the extended part are released, the mobile radio resources in the basic part may still stay reserved.

The basic mobile radio resources may be released after the mobile radio base station device (e.g. HNB or HeNB) stops operation (e.g. is switched off). The mobile radio network (e.g. the mobile radio core network 102) may detect this stop of operation and may inform the neighboring mobile radio base station device (e.g. HNB or HeNB) to re-Configure the basic part to exclude the mobile radio resources which were dedicated for this mobile radio base station device (e.g. HNB or HeNB).

The reservation and release of mobile radio resources from the extended part can be performed without signaling towards the mobile radio network (e.g. the mobile radio core network 102). Only re-configuration, start or stop of operation of a mobile radio base station device (e.g. HNB or HeNB) may require signaling from the mobile radio network (e.g. the mobile radio core network 102).

In case that a mobile radio base station device (e.g. HNB or HeNB) needs mobile radio resources from the extended part and detects that all mobile radio resources are occupied, it may try to reserve the mobile radio resources at a later time.

The embodiments have been mainly described the management of mobile radio resources used for downlink user data transmission. However, the same principles may be used for allocation and reservation of mobile radio resources for the uplink user data transmission.

It is also a valid embodiment, that mobile radio base station devices (e.g. NodeBs, eNodeBs, HNBs or HeNBs) share the same mobile radio resources with these proposed methods.

In various embodiments, methods to allocate and reserve mobile radio resources for user data to mobile radio base station devices (e.g. HNBs or HeNBs) operated in overlapping areas by sharing the same mobile radio resources are provided. The different methods may be configurable by the mobile radio network operator depending on the deployment scenario of mobile radio base station devices (e.g. HNBs or HeNBs).
After the mobile radio base station devices (e.g. HNBs or HeNBs) are registered to the mobile radio network (e.g. the mobile radio core network 102), the allocation and reservation could be done without the need for a controlling instance in the mobile radio network and therefore without signaling towards the mobile radio base station devices (e.g. HNBs or HeNBs) and the mobile radio network. This may not only prevent the mobile radio network (e.g. the mobile radio core network 102) from calculating and signaling the mobile radio resource allocation and reservation of all mobile radio base station devices (e.g. HNBs or HeNBs) connected to the mobile radio network but also leads to shorter signaling ways and less delay in case a mobile radio communication terminal device (e.g. UE) requests or releases a mobile radio resource.
Therefore, the shared mobile radio resources for user data transmission may be categorized in a plurality of e.g. two parts. A basic part and an extended part.
One basic part may be reserved for each operating mobile radio base station device (e.g. HNB or HeNB). This may guarantee a reliable quality of service. The waste of mobile radio resources is small in case it is unused, since the basic part occupies only a small amount of mobile radio resources in time and frequency. This reservation may be indicated by a message sent from the mobile radio network to the affected mobile radio base station devices (e.g. HNBs or HeNBs).
The extended part may be allocated and reserved only in case it is currently needed and it is released if it is not needed anymore. This may enable an efficient use of the mobile radio resources. The mobile radio base station device (e.g. HNB or HeNB) may allocate the mobile radio resources in case it detects that it is unused.
There is no need to modify mobile radio communication terminal's (e.g. UE's) behavior or configuration, i.e. the methods are compatible to the conventional mobile radio communication terminal (e.g. UE) behavior or configuration.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A mobile radio communication device, comprising:
a mobile radio communication protocol circuit configured to provide a home base station function for a mobile radio communication with a mobile radio communication terminal device; and
a mobile radio resources allocation and reservation circuit configured to allocate and reserve mobile radio resources to a home base station for mobile radio user data transmission between the mobile radio communication device and the mobile radio communication terminal device.

2. The mobile radio communication device of claim 1, further comprising:
a network receiver configured to receive mobile radio resources allocation and reservation information from a mobile radio network, wherein the mobile radio resources allocation and reservation information represents information about allocation and reservation of mobile radio resources for mobile radio user data transmission between the mobile radio communication device and the mobile radio communication terminal device;
wherein the mobile radio resources allocation and reservation circuit is configured to allocate and reserve mobile radio resources to a home base station for mobile radio user data transmission between the mobile radio communication device and the mobile radio communication terminal device in accordance with the received mobile radio resources allocation and reservation information.

3. The mobile radio communication device of claim 1,
wherein the mobile radio resources allocation and reservation circuit is configured to allocate and reserve mobile radio resources to a home base station for mobile radio user data transmission between the mobile radio communication device and the mobile radio communication terminal device according to a multiplexing technique selected from a group of multiplexing techniques consisting of:
time multiplexing;
frequency multiplexing;
code multiplexing; and
a combination of the mentioned multiplexing techniques.

4. The mobile radio communication device of claim 1, further comprising:
a terminal device receiver configured to receive a connection setup request from a mobile radio communication terminal device, whereas the mobile radio communication device derives information about allocation and reservation of mobile radio resources for mobile radio user data transmission between the mobile radio communication device and the mobile radio communication terminal device from the connection setup request;
wherein the mobile radio resources allocation and reservation circuit is configured to allocate and reserve mobile radio resources to a home base station for mobile radio user data transmission between the mobile radio communication device and the mobile radio communication terminal device in accordance with the received mobile radio resources allocation and reservation information.

5. The mobile radio communication device of claim 1, further comprising:
a transmitter configured to transmit reservation information to at least one other mobile radio communication device.

6. The mobile radio communication device of claim 5,
wherein the transmitter is configured to transmit pilot signals as reservation information to the other mobile radio communication device.

7. The mobile radio communication device of claim 5,
wherein the other mobile radio communication device is a mobile radio base station device.

8. The mobile radio communication device of claim 1, further comprising:
a network receiver configured to receive mobile radio resources allocation and reservation information from a mobile radio network, wherein the mobile radio resources allocation and reservation information represents information about allocation and reservation of mobile radio resources for mobile radio user data transmission between the mobile radio communication device and the mobile radio communication terminal device;
a terminal device receiver configured to receive a connection setup request from a mobile radio communication terminal device, whereas the mobile radio communication device derives information about allocation and reservation of mobile radio resources for mobile radio user data transmission between the mobile radio communication device and the mobile radio communication terminal device from the connection setup request;
wherein the mobile radio resources allocation and reservation circuit is configured to allocate and reserve
a first portion of mobile radio resources for mobile radio user data transmission between the mobile radio communication device and the mobile radio communication terminal device in accordance with mobile radio resources allocation and reservation information received from the mobile radio network; and
a second portion of mobile radio resources for mobile radio user data transmission between the mobile radio communication device and the mobile radio communication terminal device in accordance with the information derived from the connection setup request received from the mobile radio communication terminal device.

9. The mobile radio communication device of claim 1,
wherein the mobile radio resources allocation and reservation information comprises at least one of the following information:
information about the amount of mobile radio resources to be allocated and reserved;
information specifying dedicated mobile radio resources to be allocated and reserved;
information about an event resulting in a predefined allocation and reservation of mobile radio resources.

10. The mobile radio communication device of claim 1, further comprising:
a transmitter configured to transmit a request for mobile radio resources reservation to a mobile radio network.

11. A mobile radio base station device, comprising:
a mobile radio communication protocol circuit configured to provide a base station function for a mobile radio communication with a mobile radio communication terminal device; and
a mobile radio resources allocation and reservation circuit configured to variably allocate and reserve radio resources for mobile radio user data transmission between the mobile radio base station device and the mobile radio communication terminal device during run-time of the mobile radio base station device.

12. The mobile radio base station device of claim 11,
wherein the mobile radio communication protocol circuit is configured to provide a home base station function for a mobile radio communication with a mobile radio communication terminal device.

13. The mobile radio base station device of claim 11, further comprising:
a network receiver configured to receive mobile radio resources allocation and reservation information from a mobile radio network, wherein the mobile radio resources allocation and reservation information represents information about allocation and reservation of mobile radio resources for mobile radio user data transmission between the mobile radio base station device and the mobile radio communication terminal device;
wherein the mobile radio resources allocation and reservation circuit is configured to allocate and reserve mobile radio resources to a home base station for mobile radio user data transmission between the mobile radio base station device and the mobile radio communication terminal device in accordance with the received mobile radio resources allocation and reservation information.

14. The mobile radio base station device of claim 11,
wherein the mobile radio resources allocation and reservation circuit is configured to allocate and reserve mobile radio resources to a home base station for mobile radio user data transmission between the mobile radio base station device and the mobile radio communication terminal device according to a multiplexing technique selected from a group of multiplexing techniques consisting of:
time multiplexing;
frequency multiplexing;
code multiplexing; and
a combination of the mentioned multiplexing techniques.

15. The mobile radio base station device of claim 11, further comprising:
a terminal device receiver configured to receive a connection setup request from a mobile radio communication terminal device, whereas the mobile radio communication device derives information about allocation and reservation of mobile radio resources for mobile radio user data transmission between the mobile radio base station device and the mobile radio communication terminal device from the connection setup request;
wherein the mobile radio resources allocation and reservation circuit is configured to allocate and reserve mobile radio resources to a home base station for mobile radio user data transmission between the mobile radio base station device and the mobile radio communication terminal device in accordance with the received connection setup request.

16. The mobile radio base station device of claim 11, further comprising:
a transmitter configured to transmit reservation information to another mobile radio base station device.

17. The mobile radio base station device of claim 16,
wherein the other mobile radio base station device is a mobile radio home base station device.

18. The mobile radio base station device of claim 11, further comprising:
a network receiver configured to receive mobile radio resources allocation and reservation information from a mobile radio network, wherein the mobile radio resources allocation and reservation information represents information about allocation and reservation of mobile radio resources for mobile radio user data transmission between the mobile radio base station device and the mobile radio communication terminal device;
a terminal device receiver configured to receive a connection setup request from a mobile radio communication terminal device, whereas the mobile radio communication device derives information about allocation and reservation of mobile radio resources for mobile radio user data transmission between the mobile radio base station device and the mobile radio communication terminal device from the connection setup request;
wherein the mobile radio resources allocation and reservation circuit is configured to allocate and reserve
a first portion of mobile radio resources for mobile radio user data transmission between the mobile radio base station device and the mobile radio communication terminal device in accordance with mobile radio resources allocation and reservation information received from the mobile radio network; and
a second portion of mobile radio resources for mobile radio user data transmission between the mobile radio base station device and the mobile radio communication terminal device in accordance with the information derived from the connection setup request received from the mobile radio communication terminal device.

19. A mobile radio base station device, comprising:
a mobile radio communication protocol circuit configured to provide a base station function for a mobile radio communication with a mobile radio communication terminal device;
a mobile radio resources allocation and reservation circuit configured to allocate and reserve radio resources for radio user data transmission between the mobile radio base station device and the radio communication terminal device; and
a mobile radio resources allocation and reservation circuit controller configured to control allocation and reservation of radio resources for mobile radio user data transmission between the mobile radio base station device and the mobile radio communication terminal device.

20. The mobile radio base station device of claim 19,
wherein the mobile radio communication protocol circuit is configured to provide a home base station function for a mobile radio communication with a mobile radio communication terminal device; and

21. The mobile radio base station device of claim 19, further comprising:
a network receiver configured to receive mobile radio resources allocation and reservation information from a mobile radio network, wherein the mobile radio resources allocation and reservation information represents information about allocation and reservation of mobile radio resources for mobile radio user data transmission between the mobile radio base station device and the mobile radio communication terminal device;
wherein the mobile radio resources allocation and reservation circuit controller is configured to control the mobile radio resources allocation and reservation circuit to allocate and reserve mobile radio resources to a home base station for mobile radio user data transmission between the mobile radio base station device and the mobile radio communication terminal device in accordance with the received mobile radio resources allocation and reservation information.

22. The mobile radio base station device of claim 19, further comprising:
a terminal device receiver configured to receive a connection setup request from a mobile radio communication terminal device, whereas the mobile radio communication device derives information about allocation and reservation of mobile radio resources for mobile radio user data transmission between the mobile radio base station device and the mobile radio communication terminal device from this connection setup request;
wherein the mobile radio resources allocation and reservation circuit controller is configured to control the mobile radio resources allocation and reservation circuit to allocate and reserve mobile radio resources to a home base station for mobile radio user data transmission between the mobile radio base station device and the mobile radio communication terminal device in accordance with the information derived from the connection setup request.

23. The mobile radio base station device of claim 19, further comprising:
a network receiver configured to receive mobile radio resources allocation and reservation information from a mobile radio network, wherein the mobile radio resources allocation and reservation information represents information about allocation and reservation of mobile radio resources for mobile radio user data transmission between the mobile radio base station device and the mobile radio communication terminal device;
a terminal device receiver configured to receive a connection setup request from a mobile radio communication terminal device, whereas the mobile radio communication device derives information about allocation and reservation of mobile radio resources for mobile radio user data transmission between the mobile radio base station device and the mobile radio communication terminal device from the connection setup request;
wherein the mobile radio resources allocation and reservation circuit controller is configured to control the mobile radio resources allocation and reservation circuit to allocate and reserve
a first portion of mobile radio resources for mobile radio user data transmission between the mobile radio base station device and the mobile radio communication terminal device in accordance with mobile radio resources allocation and reservation information received from the mobile radio network; and
a second portion of mobile radio resources for mobile radio user data transmission between the mobile radio base station device and the mobile radio communication terminal device in accordance with the information derived from the connection setup request.

24. A mobile radio communication device, comprising:
a controller configured to implement:
a home base station function for a mobile radio communication with a mobile radio communication terminal device; and
an allocation and reservation of mobile radio resources for mobile radio user data transmission between the mobile radio communication device and the mobile radio communication terminal device.

25. A mobile radio base station device, comprising:
a controller configured to implement:
a base station function for a mobile radio communication with a mobile radio communication terminal device;
an allocation and reservation of mobile radio resources for mobile radio user data transmission between the mobile radio base station device and the mobile radio communication terminal device; and
controlling the allocation and reservation of radio resources for mobile radio user data transmission between the mobile radio base station device and the mobile radio communication terminal device.
